(19) United States
(12) Patent Application Publication
(10) Pub. No.: US 2026/0042936 A1
(43) Pub. Date: Feb. 12, 2026

(54) ADHESIVE FILM AND ARTICLE PROVIDED WITH ADHESIVE FILM

(71) Applicant: AGC INC., Tokyo (JP)

(72) Inventors: Koichi ODA, Chiyoda-ku (JP); Satoshi TAKENAKA, Chiyoda-ku (JP)

(73) Assignee: AGC INC., Tokyo (JP)

(21) Appl. No.: 19/360,070

(22) Filed: Oct. 16, 2025

Related U.S. Application Data
(63) Continuation of application No. PCT/JP2024/015143, filed on Apr. 16, 2024.

(30) Foreign Application Priority Data
Apr. 18, 2023 (JP) 2023-068089

(51) Int. Cl. C09J 7/24; C09J 7/30; C09J 11/04

(52) U.S. Cl. CPC C09J 7/24; C09J 7/30; C09J 11/04; C09J 2301/41

(57) ABSTRACT

The adhesive film includes a fluororesin layer containing a fluororesin and a pigment; and an adhesive layer that contains a silane coupling agent having a functional group and that is provided on at least a part of the fluororesin layer, in which a content of the pigment in the fluororesin layer is 1.0% by mass or more.

### CROSS-REFERENCE TO RELATED APPLICATIONS

This application is a Continuation application of International Application No. PCT/JP2024/015143, filed Apr. 16, 2024, the disclosure of which is incorporated herein by reference in its entirety. Further, this application claims priority from Japanese Patent Application No. 2023-068089, filed Apr. 18, 2023, the disclosure of which is incorporated herein by reference in its entirety.

### TECHNICAL FIELD

The present invention relates to an adhesive film and an article provided with an adhesive film.

### BACKGROUND ART

Fluororesin films using fluororesin have excellent properties such as weather resistance, water repellency, and oil repellency, and are utilized as protective films for various substrates. In particular, in recent years, utilization as a protective film for substrates used outdoors has been expected, and in order to protect the substrate from sunlight, an ultraviolet shielding function is required.

Patent Literature 1 describes a resin film, for the purpose of improving weather resistance, in which composite particles having a coating layer containing aluminum oxide on the surface of titanium oxide particles and composite particles having a coating layer containing silicon oxide on the surface of zinc oxide particles are contained in a resin containing fluororesin.

### CITATION LIST

### Patent Literature

Patent Literature 1: International Patent Publication 2014/021436

### SUMMARY OF INVENTION

### Technical Problem

However, since the adhesiveness of the fluororesin film itself is poor, it is desired to impart adhesiveness to the fluororesin film in order to improve the adhesive strength between the substrate and the fluororesin film. In Patent Literature 1 as well, it is described that, when utilized for the backsheet of a solar cell, a two-component curable urethane-based adhesive may be used to bond the fluororesin film and the moisture barrier layer via an adhesion layer.

As described in Patent Literature 1, there are applications in which sufficient adhesive strength can be achieved for bonding a fluororesin film to a substrate by using a two-component curable urethane-based adhesive. However, in cases where the film is exposed to an outdoor environment for a long period of time, a fluororesin film having an adhesive layer with further adhesive strength with respect to the substrate in a weather resistance test is desired, and a proposal for a method of imparting optimal adhesive strength with respect to the fluororesin film and the substrate is desired.

An object of one aspect of the disclosure is to provide an adhesive film excellent in adhesive strength with respect to a substrate even after a weather resistance test, and an article provided with an adhesive film excellent in adhesive strength with respect to a substrate even after a weather resistance test.

### Solution to Problem

Specific means for achieving the above object are as follows.

<1> An adhesive film including:
a fluororesin layer containing a fluororesin and a pigment; and
an adhesive layer that contains a silane coupling agent having a functional group and that is provided on at least a part of the fluororesin layer,
in which a content of the pigment in the fluororesin layer is 1.0% by mass or more.

<2> The adhesive film according to <1>, in which the pigment includes at least one selected from the group consisting of titanium oxide and carbon black.

<3> The adhesive film according to <1> or <2>, in which the pigment includes titanium oxide and aluminum oxide.

<4> The adhesive film according to any one of <1> to <3>, in which the functional group of the silane coupling agent includes at least one selected from the group consisting of an amino group, an epoxy group, and an acrylic group.

<5> The adhesive film according to any one of <1> to <4>, in which an amount of the functional group of the silane coupling agent included in the adhesive layer is 0.01 mmol/m² or more.

<6> The adhesive film according to any one of <1> to <5>, in which the fluororesin includes an ethylene-tetrafluoroethylene copolymer.

<7> The adhesive film according to any one of <1> to <6>, in which the fluororesin layer satisfies the following Relational Formula (1):

$$100 < ( Content of the pigment in the fluororesin layer ( \% by mass ) \times Average thickness of the fluororesin layer ( μm ) ) < 2100 . \qquad Formula ( 1 )$$

<8> The adhesive film according to any one of <1> to <7>, in which the adhesive film has a transmittance of 1.0% or less at a wavelength of 360 nm

<9> The adhesive film according to any one of <1> to <8>, in which an average thickness of the adhesive layer is 0.5 μm or less.

<10> The adhesive film according to any one of <1> to <9>, in which an amount of the functional group of the silane coupling agent included in the adhesive layer is from 0.01 to 0.7 mmol/m².

<11> The adhesive film according to any one of <1> to <10>, which is a protective film for outdoor use.

<12> An article including:
the adhesive film according to any one of <1> to <11>; and
a substrate,
in which the fluororesin layer, the adhesive layer, and the substrate are provided in this order.

<13> The article according to <12>, in which the substrate includes at least one selected from the group consisting of glass, polycarbonate, polyvinyl chloride, epoxy resin, acrylic resin, ethylene-vinyl acetate copolymer resin, modified polyethylene, and fiber-containing resin.

<14> The article according to <12> or <13>, in which the adhesive film is a protective film.

<15> The article according to any one of <12> to <14>, which is for outdoor use.

### Advantageous Effects of Invention

According to one aspect of the disclosure, it is possible to provide an adhesive film having excellent adhesive strength with respect to a substrate even after a weather resistance test, and an article provided with an adhesive film having excellent adhesive strength with respect to a substrate even after a weather resistance test.

### BRIEF DESCRIPTION OF DRAWINGS

FIG. 1 is a schematic cross-sectional view showing a layer structure of an example of an adhesive film of the disclosure.

FIG. 2 is a schematic cross-sectional view showing a layer structure of an example of an adhesive film of the disclosure.

### DESCRIPTION OF EMBODIMENTS

Hereinafter, an embodiment of the disclosure will be described in detail. However, the disclosure is not limited to the following embodiments. In the following embodiments, the constituent elements (including element steps and the like) are not essential unless otherwise specified. The same applies to numerical values and ranges thereof, and the disclosure is not limited thereto.

In the disclosure, the numerical ranges indicated using “to” include the numerical values before and after “to” as the minimum and maximum values, respectively.

In the numerical ranges described step by step in the disclosure, the upper limit value or the lower limit value of one numerical range may be replaced with the upper limit value or the lower limit value of another numerical range described step by step. In the numerical ranges described in the disclosure, the upper limit value or the lower limit value of the numerical ranges may be replaced with the values shown in the examples.

In the disclosure, each component may contain plural types of corresponding substances. When plural types of substances corresponding to each component are present in the composition, the content or content amount of each component means the total content or content amount of the plural types of substances present in the composition unless otherwise specified.

In the disclosure, the particles corresponding to each component may include plural types of particles. When there are plural types of particles corresponding to each component in the composition, the particle diameter of each component means a value for a mixture of the plural types of particles present in the composition unless otherwise specified.

In the disclosure, the term “layer” includes a case where the layer is formed only in a part of the region in addition to a case where the layer is formed in the entire region when the region where the layer exists is observed.

When an embodiment is described with reference to the drawings in the disclosure, the structure of the embodiment is not limited to the structure shown in the drawings. The sizes of the members in each drawing are conceptual, and the relative relationship between the sizes of the members is not limited thereto.

In the disclosure, the “unit” of a polymer means a portion derived from a monomer that is present in the polymer and constitutes the polymer. A unit obtained by chemically converting the structure of a certain unit after formation of a polymer is also referred to as a unit. In some cases, a unit derived from an individual monomer is referred to by a name in which “unit” is added to the monomer name.

In the disclosure, films and sheets are referred to as “films” regardless of their thickness.

### <Adhesive Film>

An adhesive film according to an aspect of the disclosure includes: a fluororesin layer containing a fluororesin and a pigment; and an adhesive layer that contains a silane coupling agent having a functional group and that is provided on at least a part of the fluororesin layer, and a content of the pigment in the fluororesin layer is 1.0% by mass or more.

By adopting the above structure, the reason for the excellent adhesive strength with respect to the substrate even after a weather resistance test is presumed to be as follows, but is not limited to the following presumption.

Since the adhesive film according to one aspect of the disclosure contains 1.0% by mass or more of the pigment in the fluororesin layer, the amount of ultraviolet rays transmitted through the fluororesin layer can be reduced, and the amount of ultraviolet rays reaching the adhesive layer and the substrate can be reduced. Accordingly, it is possible to suppress deterioration of the adhesive layer and the substrate due to ultraviolet rays, and to obtain an adhesive film excellent in adhesive strength even after a weather resistance test.

As a method of imparting adhesiveness to the fluororesin layer, a method of subjecting the fluororesin layer to a surface treatment by corona discharge treatment, plasma treatment or the like, a method of providing an adhesive layer of urethane or the like on the fluororesin layer subjected to the surface treatment, and the like are considered.

As described above, among various adhesion methods, the adhesive film according to an aspect of the disclosure has an adhesive layer containing a silane coupling agent having a functional group, and thus has excellent adhesiveness to various substrates, and sufficiently exhibits an adhesive function between the fluororesin layer and the substrate. It is considered that the sufficient exhibition of the adhesion function by the adhesive layer containing such a silane coupling agent is exhibited by further containing 1.0% by mass or more of the pigment in the fluororesin.

### [Fluororesin Layer]

The fluororesin layer according to one aspect of the disclosure contains a fluororesin and a pigment, and the content of the pigment in the fluororesin layer is 1.0% by mass or more.

An average thickness of the fluororesin layer according to one aspect of the disclosure is preferably 10 μm or more, more preferably 12 μm or more, and still more preferably 20 μm or more. The lower limit value is preferably 300 μm or less, and more preferably 250 μm or less. Within the above range, excellent followability is obtained during lamination or processing with the substrate. When the average thickness of the fluororesin layer can be measured with a micrometer, the average value may be calculated by measuring at 5 points with a micrometer. When the average thickness cannot be measured with a micrometer, the average thickness may be measured in accordance with ISO 4591:1992 (Method B1 of JIS K7130:1999, a method of measuring thickness by the mass method of a sample taken from a plastic film or sheet). In the disclosure, measurement is performed in accordance with ISO 4591:1992 (Method B1 of JIS K7130:1999, a method of measuring thickness by the mass method of a sample taken from a plastic film or sheet).

### (Resin)

The resin contained in the fluororesin layer contains at least a fluororesin. One type of the fluororesin may be used alone, or two or more types thereof may be used in combination.

The fluororesin is not particularly limited as long as the fluororesin contains fluorine in the molecular structure of the resin, and is preferably a thermoplastic resin, a known fluororesin can be used, and a fluoroolefin-based polymer is preferable. The fluoroolefin-based polymer is a polymer having a fluoroolefin unit. The fluoroolefin-based polymer may further have a monomer unit other than the fluoroolefin unit.

Examples of the fluoroolefin unit include units derived from tetrafluoroethylene, vinyl fluoride, vinylidene fluoride, trifluoroethylene, hexafluoropropylene, and chlorotrifluoroethylene. Among them, the tetrafluoroethylene unit is preferable from the viewpoint of excellent weather resistance, heat resistance, stain resistance, and the like. One type of fluoroolefin unit may be used alone, or two or more types thereof may be used in combination.

Examples of polymers having tetrafluoroethylene units as fluoroolefin units include tetrafluoroethylene-perfluoro (alkyl vinyl ether) copolymer (hereinafter also referred to as “PFA”), tetrafluoroethylene-hexafluoropropylene-perfluoro (alkyl vinyl ether) copolymer, tetrafluoroethylene-hexafluoropropylene copolymer (hereinafter also referred to as “FEP”), ethylene-tetrafluoroethylene copolymer (hereinafter also referred to as “ETFE”), and ethylene-trichlorofluoroethylene copolymer (hereinafter also referred to as “ECTFE”). One type of the polymer having a tetrafluoroethylene unit may be used alone, or two or more types thereof may be used in combination.

Among them, PFA, FEP, ETFE, and ECTFE are preferable. Among them, ETFE is particularly preferable from the viewpoint of cost and mechanical strength.

ETFE is a copolymer having ethylene (hereinafter also referred to as “E”) units (hereinafter also referred to as “E units”) and tetrafluoroethylene (hereinafter also referred to as “TFE”) units (hereinafter also referred to as “TFE units”). The ETFE may further have a constituent unit derived from another monomer other than E and TFE as necessary.

A molar ratio of E units/TFE units in ETFE is preferably from 40/60 to 70/30, and more preferably from 40/60 to 60/40.

In 100% by mole of all units constituting ETFE, a total content amount of the E units and the TFE units is preferably 90% by mole or more, more preferably 95% by mole or more, and may be 100% by mole.

As other monomer units in ETFE, those that can be copolymerized with E and TFE may be used, examples thereof include fluoroethylene units derived from monomers such as CF₂═CFCl and CF₂═CH₂; fluoropropylene units derived from monomers such as CF₂═CFCF₃ and CF₂═CHCF₃; fluorinated alkylethylene units having a fluoroalkyl group with 2 to 10 carbon atoms, derived from monomers such as CH₂═CHC₂F₅, CH₂═CHC₄F₉, CH₂═CFC₄F₉, and CH₂═CF(CF₂)₃H; perfluoro (alkyl vinyl ether) units derived from monomers such as CF₂═CFO(CF₂CFXO)ₘR^{f} (in the formula, R^{f} represents a perfluoroalkyl group having 1 to 6 carbon atoms, X represents a fluorine atom or a trifluoromethyl group, and m represents an integer of 1 to 5); and vinyl ether units having a group convertible to a carboxylic acid group or a sulfonic acid group, derived from monomers such as CF₂═CFOCF₂CF₂CF₂COOCH₃ and CF₂═CFOCF₂CF(CF₃)OCF₂CF₂SO₂F. One type of the other monomer unit may be used alone, or two or more types thereof may be used in combination.

When ETFE has other monomer units, a content amount of the other monomer units in 100% by mole of all units constituting ETFE is preferably from 0.01 to 10% by mole, more preferably from 0.05 to 5% by mole, and still more preferably 0.1 to 4% by mole.

The resin contained in the fluororesin layer may contain a resin other than the fluororesin.

Examples of other resins include acrylic resin, polycarbonate resin, polyethylene resin, polypropylene resin, polyethylene terephthalate, polybutylene terephthalate, and nylon. One type of resin other than the fluororesin may be used alone, or two or more types thereof may be used in combination.

A proportion of the fluororesin in the fluororesin layer is preferably 50% by mass or more, more preferably 90% by mass or more, still more preferably 98% by mass or more, and particularly preferably 100% by mass. When the proportion of the fluororesin in the fluororesin layer is 50% by mass or more, heat resistance is excellent.

### (Pigment)

As the pigment contained in the fluororesin layer, a known pigment can be used, and from the viewpoint of excellent weather resistance, a pigment that decreases the transmittance in the ultraviolet region and is excellent in ultraviolet shielding properties is preferable. Examples include black pigments typified by carbon black, blue pigments typified by cobalt oxide, red pigments typified by iron oxide, yellow pigments such as cerium oxide, and white pigments typified by titanium oxide, silicon oxide, and zinc oxide. Among them, from the viewpoint of excellent ultraviolet shielding properties, carbon black or titanium oxide is preferable, and titanium oxide is particularly preferable. One type of the pigment may be used alone, or two or more types thereof may be used in combination. In addition, as long as the ability of the ultraviolet shielding properties is not impaired, a pigment may be used by being coated with other pigments, inorganic substances, organic substances, and combinations thereof.

A content amount of the pigment in the fluororesin layer is 1.0% by mass or more, more preferably 2.0% by mass or more, and particularly preferably 2.5% by mass or more. The upper limit value is preferably 15.0% by mass or less, more preferably 13.0% by mass or less, and still more preferably 11.0% by mass or less.

When the content amount of the pigment is 1.0% by mass or more, the amount of ultraviolet rays transmitted through the fluororesin layer is reduced, and the amount of ultraviolet rays reaching the adhesive layer and the substrate can be reduced. Accordingly, an adhesive film excellent in ultraviolet shielding properties, capable of suppressing deterioration of the adhesive layer and the substrate by ultraviolet rays, and excellent in adhesive strength even after a weather resistance test can be obtained. When the content is equal to or less than the upper limit value, the kneadability when the pigment is kneaded into the resin is excellent, and the obtained adhesive film is excellent in the effect of hiding the substrate, which is preferable. The effect of hiding the substrate refers to that when the adhesive film and the substrate are laminated, patterns, characters, fibers, and the like of the substrate cannot be visually recognized from the fluororesin layer side of the adhesive film, and when the effect of hiding the substrate is excellent, the designability of an article obtained by laminating the adhesive film and the substrate is excellent.

When a pigment having a catalytic active function is used as the pigment, the catalytic active function of the pigment is expressed by light or heat when the pigment is used outdoors, and deterioration of the fluororesin layer may be caused, for example, the generation of voids due to reaction with the fluororesin in the fluororesin layer. However, when the content amount of the pigment is 1.0% by mass or more, even when the catalytic activity function is exhibited by some of the pigments, the ultraviolet shielding effect is sufficiently exhibited because the amount of the remaining pigments is sufficient, and the continuous expression of the catalytic activity of the pigments due to light or heat can be suppressed.

The content amount of the pigment contained in the fluororesin layer may be determined from a theoretical value calculated from the amount of the pigment added when preparing the fluororesin layer, or may be determined by firing the fluororesin layer to burn off the resin, and measuring the weight before and after firing using an analytical balance (for example, AUX320 manufactured by Shimadzu Corporation).

A content of the pigment contained in the fluororesin layer is preferably appropriately adjusted in accordance with the average thickness of the fluororesin layer in order to sufficiently exhibit the ultraviolet shielding effect.

When the average thickness of the fluororesin layer is from 10 μm to less than 20 μm, the content of the pigment is preferably from 10.0% by mass to 15.0% by mass.

When the average thickness of the fluororesin layer is from 20 μm to less than 50 μm, the content of the pigment is preferably from 5.0% by mass to 15.0% by mass.

When the average thickness of the fluororesin layer is from 50 μm to less than 75 μm, the content of the pigment is preferably from 2.0% by mass to 15.0% by mass, and more preferably from 12.0% by mass to 15.0% by mass.

When the average thickness of the fluororesin layer is from 75 μm to less than 100 μm, the content of the pigment is preferably from 2.0% by mass to 15.0% by mass, and more preferably from 7.0% by mass to 13.0% by mass.

When the average thickness of the fluororesin layer is from 100 μm to less than 150 μm, the content of the pigment is preferably from 1.0% by mass to 15.0% by mass, and more preferably from 6.0% by mass to 10.0% by mass.

When the average thickness of the fluororesin layer is from 150 μm to less than 200 μm, the content of the pigment is preferably from 1.0% by mass to 14.0% by mass, and more preferably from 5.0% by mass to 6.0% by mass.

When the average thickness of the fluororesin layer is from 200 μm to less than 250 μm, the content of the pigment is preferably from 1.0% by mass to 10.0% by mass, more preferably from 2.5% by mass to 5.0% by mass, and may be from 3.0% by mass to 5.0% by mass.

When the average thickness of the fluororesin layer is from 250 μm to 300 μm or less, the content of the pigment is preferably from 1.0% by mass to 7.0% by mass, and more preferably from 2.0% by mass to 3.0% by mass.

The fluororesin layer preferably satisfies the following Relational Formula (1).

$$100 < ( Content of the pigment in the fluororesin layer ( \% by mass ) \times Average thickness of the fluororesin layer ( μm ) ) < 2100 . \qquad Formula ( 1 )$$

A content of the pigment in the fluororesin layer (% by mass)×the average thickness of the fluororesin layer (μm) is preferably from 100 to 2100, more preferably from 500 to 1500, and preferably from 610 to 1000.

Within the above range, the adhesive film is excellent in the ultraviolet shielding properties and the effect of hiding the substrate. In addition, moldability of the fluororesin layer and moldability when the substrate and the adhesive film are laminated are excellent. The adhesive film is also excellent in adhesive strength after a weather resistance test.

The content of the pigment in the fluororesin layer and the average thickness of the fluororesin layer are preferably in the above-mentioned ranges.

A calculation example of the relational formula of Formula (1) is described in Table 1.

TABLE 1

| | | Average thickness of fluororesin layer (μm) | | | | | | |
|---|---|---|---|---|---|---|---|---|
| | | 25 | 50 | 75 | 100 | 150 | 200 | 250 |
| Pigment | 12.5 | 312.5 | 625 | 937.5 | 1250 | 1875 | 2500 | 3125 |
| content | 10.0 | 250 | 500 | 750 | 1000 | 1500 | 2000 | 2500 |
| (% by mass) | 8.3 | 207.5 | 415 | 622.5 | 830 | 1245 | 1660 | 2075 |
| | 5.0 | 125 | 250 | 375 | 500 | 750 | 1000 | 1250 |
| | 3.0 | 75 | 150 | 225 | 300 | 450 | 600 | 750 |
| | 2.0 | 50 | 100 | 150 | 200 | 300 | 400 | 500 |

An average particle diameter of the pigment is preferably from 0.10 to 5.0 μm, and more preferably from 0.15 to 2.0 μm.

When the average particle diameter of the pigment is within the above range, the ultraviolet shielding function is excellent.

The average particle diameter of the pigment is a value obtained by observing the fluororesin layer with a scanning electron microscope, measuring the particle diameters of 20 particles randomly extracted, and averaging the particle diameters.

When the pigment contains titanium oxide, the pigment preferably contains titanium oxide and aluminum oxide. Since titanium oxide has a catalytic active function, it is more preferable to use composite particles of titanium oxide (hereinafter also referred to as “titanium oxide composite particles”) having a coating layer containing at least aluminum oxide on the surface of titanium oxide.

A proportion of titanium oxide in the titanium oxide composite particles is preferably 95% by mass or more, and more preferably 95.5% by mass or more, with respect to 100% by mass of the total mass of the titanium oxide composite particles (the total of the titanium oxide and the coating layer). When the proportion of titanium oxide is 95% by mass or more, an excellent ultraviolet shielding effect is exhibited in the fluororesin.

The upper limit of the proportion of titanium oxide in the titanium oxide composite particles is not particularly limited, but is, for example, 99.9% by mass.

A proportion of the coating layer in the titanium oxide composite particles is preferably from 0.6 to 4.5% by mass, more preferably from 1.0 to 4.0% by mass, and still more preferably from 1.0 to 3.5% by mass with respect to 100% by mass of the total mass of the titanium oxide composite particles. When the proportion of the coating layer in the titanium oxide composite particles is 3.5% by mass or less, foaming streaks are less likely to occur during molding of the fluororesin layer, and a fluororesin layer having a good appearance is easily obtained. In another aspect, the proportion of the coating layer in the titanium oxide composite particles is from 0.6 to 2.5% by mass, from 1.0 to 2.5% by mass, or from 1.0 to 2.0% by mass with respect to 100% by mass of the total mass of the titanium oxide composite particles.

The coating layer of the titanium oxide composite particles contains at least aluminum oxide.

The coating layer of the titanium oxide composite particles exhibits an effect of preventing aggregation between the composite particles and an effect of reducing the catalytic activity of titanium oxide by containing aluminum oxide.

A proportion of aluminum oxide in the titanium oxide composite particles is preferably from 0.6 to 2.5% by mass, more preferably from 1.0 to 2.5% by mass, and still more preferably from 1.0 to 2.0% by mass with respect to 100% by mass of the total mass of the titanium oxide composite particles. When the proportion of aluminum oxide in the titanium oxide composite particles is 2.5% by mass or less, foaming streaks are less likely to occur during molding of the fluororesin layer, and a fluororesin layer having a good appearance is easily obtained.

The coating layer of the titanium oxide composite particles may contain an inorganic component other than aluminum oxide. Examples of other inorganic components include phosphorus oxide, sodium oxide, silicon oxide, zirconium oxide, and cerium oxide. One type of the other inorganic components may be used alone, or two or more types thereof may be used in combination.

A total amount of the silicon oxide, the zirconium oxide, and the cerium oxide is preferably 2.5% by mass or less, more preferably 2.0% by mass or less, and may be 1.0% by mass or less or 0.8% by mass or less with respect to 100% by mass of the total mass of the titanium oxide composite particles.

On the other hand, phosphorus oxide, particularly phosphate ions can be contained in any proportion as long as the total amount of phosphorus oxide and aluminum oxide is within a range of 4% by mass or less, and preferably 3% by mass or less, with respect to 100% by mass of the total mass of the titanium oxide composite particles.

The coating layer of the titanium oxide composite particles may be a single layer or a multilayer.

When the coating layer of the titanium oxide composite particles contains an inorganic component other than aluminum oxide, the inorganic component may be contained in the same layer as aluminum oxide or in another layer.

Among the inorganic components, phosphorus oxide and sodium oxide may be contained in the aluminum oxide layer as impurities. When silicon oxide or zirconium oxide is contained, a silicon oxide layer or a zirconium oxide layer is preferably provided separately from the aluminum oxide layer. In this case, the aluminum oxide layer is preferably provided outside the other layers (silicon oxide layer or zirconium oxide layer).

The coating layer of the titanium oxide composite particles may have a surface treatment agent layer on the outermost layer.

Examples of the surface treatment agent constituting the surface treatment agent layer include an antioxidant and a hydrophobizing agent. When an antioxidant is used as the surface treatment agent, coloration during compounding can be prevented. When the hydrophobizing agent is used as the surface treatment agent, aggregation of the titanium oxide composite particles in the fluororesin layer can be suppressed.

As the antioxidant, a known antioxidant such as a phosphorus-containing antioxidant, a phenol antioxidant, or a sulfur-containing antioxidant can be used.

Examples of the hydrophobizing agent include a silane coupling agent having an alkyl group and a silicone compound.

Examples of silane coupling agents having an alkyl group include trialkoxysilanes such as isobutyltrimethoxysilane, hexyltrimethoxysilane, and (3,3,3-trifluoropropyl) trimethoxysilane; silazanes such as hexamethyldisilazane; and chlorosilanes such as dimethyldichlorosilane. Among them, isobutyltrimethoxysilane is preferable.

The silicone compound is an organopolysiloxane having an organic group. The organic group is preferably an alkyl group having 4 or less carbon atoms or a phenyl group.

As the silicone compound, a compound generally called silicone oil can be used. Examples of silicone oils include straight silicone oils such as dimethyl silicone oil and phenylmethyl silicone oil, alkyl-modified silicone oils, alkylaryl-modified silicone oils, and fluorinated alkyl-modified silicone oils. Among them, dimethyl silicone oil is preferable from the viewpoint of cost, and phenylmethyl silicone oil is preferable from the viewpoint of heat resistance.

As the silicone compound, a commercially available product can be used. Examples of the dimethyl silicone oil include SH200 (product name) manufactured by Dow Corning Toray Silicone Co., Ltd., KF96 (product name) manufactured by Shin-Etsu Chemical Co., Ltd., TSF451 (product name) manufactured by Momentive Performance Materials, and the like, which have various molecular weights (viscosities). Examples of the phenylmethyl silicone oil include SH510 (product name), SH550 (product name), and SH710 (product name) manufactured by Dow Corning Toray Silicone Co., Ltd., and KF54 (product name) manufactured by Shin-Etsu Chemical Co., Ltd.

The hydrophobizing agent is preferably a silicone compound. In the case of using a silicone compound, the curing of the fluororesin layer scarcely proceeds even by long-term outdoor exposure, and the flexibility is easily maintained. The reason is not clear, but it is presumed that the silicone compound has an effect of inhibiting crystallization of the fluororesin.

When the surface treatment agent layer is provided, a proportion of the surface treatment agent layer in the titanium oxide composite particles is preferably from 0.3 to 2.5% by mass, and more preferably from 0.5 to 1.5% by mass with respect to the total mass of the composite particles before providing the surface treatment agent layer, that is, the total mass of particles (inorganic particles) composed of an inorganic component such as titanium oxide or aluminum oxide. When the proportion is 0.3% by mass or more, the effect of providing the surface treatment agent layer can be sufficiently obtained. When the proportion is more than 2.5% by mass, when the heat resistance of the surface treatment agent is low, a large amount of thermal decomposition product of the surface treatment agent is generated during film molding and adheres to the die, and there is a possibility that lip cleaning needs to be frequently performed.

As the titanium oxide composite particles, particles produced by a known production method may be used, or commercially available products may be used.

Examples of commercially available products that can be used as the titanium oxide composite particles include Ti-Pure (registered trademark) R-101, R-102, R-103, R-104, and R-350 manufactured by the Chemours Company; TiONA (registered trademark) RCL-69, TiONA (registered trademark) 188, and TRONOX (registered trademark) CR470 manufactured by Tronox Limited; 2230 and 2233 manufactured by Kronos Worldwide, Inc.; and CR50, CR63 manufactured by Ishihara Sangyo Kaisha, Ltd, and the like. These commercially available products may be further provided with a surface treatment agent layer.

When titanium oxide composite particles are used as the pigment, a content amount of the titanium oxide composite particles in the fluororesin layer is preferably 1.0% by mass or more, more preferably 2.0% by mass or more, and still more preferably 2.5% by mass or more. The upper limit value is preferably 15.0% by mass or less, more preferably 13.0% by mass or less, and still more preferably 11.0% by mass or less.

When the content amount of the titanium oxide composite particles in the fluororesin layer is 1.0% by mass or more, the amount of ultraviolet rays transmitted through the fluororesin layer is reduced, and the amount of ultraviolet rays reaching the adhesive layer and the substrate can be further reduced. Therefore, it is possible to suppress deterioration of the adhesive layer and the substrate due to ultraviolet rays, and it is possible to obtain an adhesive film having more excellent adhesive strength after a weather resistance test. When the content is equal to or less than the upper limit value, the kneadability when the pigment is kneaded into the fluororesin is more excellent.

The content amount of each component in the titanium oxide composite particles can be measured by using a scanning fluorescent X-ray analyzer (for example, ZSX Primus II manufactured by Rigaku Corporation) on the fluororesin layer.

An average particle diameter of the titanium oxide composite particles is preferably from 0.15 to 0.40 μm, and more preferably from 0.17 to 0.30 μm.

When the average particle diameter is 0.15 μm or more, the specific surface area of titanium oxide in the titanium oxide composite particles is reduced, and the expression of catalytic activity is effectively suppressed. From the viewpoint of effectively suppressing the expression of the catalytic activity, the average particle diameter is preferably 0.15 μm or more in order to reduce the specific surface area of titanium oxide in the titanium oxide composite particles. When the average particle diameter is 0.40 μm or less, the ultraviolet shielding function is excellent.

The average particle diameter of the titanium oxide composite particles is a value obtained by observing the fluororesin layer with an electron microscope, measuring the particle diameters of 20 particles randomly extracted, and averaging the particle diameters.

As the pigment, zinc oxide particles may be used, or zinc oxide composite particles having a coating layer containing at least silicon oxide on the surface of the zinc oxide particles may be used. The zinc oxide composite particles are preferably used in combination with titanium oxide or titanium oxide composite particles. In particular, when the content amount of the titanium oxide or titanium oxide composite particles contained in the fluororesin layer is 5.0% by mass or less, by using the zinc oxide composite particles and the titanium oxide or titanium oxide composite particles in combination, the catalytic activity of the titanium oxide or titanium oxide composite particles can be sufficiently suppressed, and more excellent weather resistance can be obtained.

As such effects, it is considered that the zinc oxide composite particles function as an ultraviolet shielding agent to reduce the amount of ultraviolet rays incident on the titanium oxide or titanium oxide composite particles, and as an acid acceptor for hydrofluoric acid generated by photodecomposition of the fluororesin, thereby suppressing the chain progression of the photodecomposition reaction of the fluororesin by hydrofluoric acid, are exerted, and that these effects act synergistically.

A mass ratio of zinc oxide to silicon oxide (ZnO/SiO₂) in the zinc oxide composite particles is preferably from 40/60 to 85/15, more preferably from 50/50 to 85/15, still more preferably from 50/50 to 80/20, and may be from 60/40 to 80/20.

When ZnO/SiO2 is within the above range, an effect of gradually and efficiently neutralizing hydrofluoric acid is exhibited, and an adhesive film having more excellent weather resistance is obtained.

When the mass ratio is the upper limit value or less, the neutralization effect on hydrofluoric acid tends to be maintained for a long time. When the mass ratio is the lower limit value or more, aggregation between the zinc oxide composite particles is effectively suppressed.

The coating layer of the zinc oxide composite particles may contain an inorganic component other than silicon oxide. Examples of other inorganic components include phosphorus oxide, sodium oxide, aluminum oxide, zirconium oxide, and cerium oxide.

A total amount of zinc oxide and silicon oxide in the zinc oxide composite particles is preferably 80% by mass or more, and more preferably 85% by mass or more. When the total amount is 80% by mass or more, the above effect is sufficiently exhibited.

The coating layer of the zinc oxide composite particles may be a single layer or a multilayer.

When the coating layer of the zinc oxide composite particles contains an inorganic component other than silicon oxide, the inorganic component may be contained in the same layer as silicon oxide or in another layer.

Among the inorganic components, phosphorus oxide and sodium oxide may be contained in the silicon oxide layer as impurities. When aluminum oxide or zirconium oxide is contained, an aluminum oxide layer or a zirconium oxide layer is preferably provided separately from the silicon oxide layer. In this case, the aluminum oxide layer is preferably provided outside the other layers (aluminum oxide layer or zirconium oxide layer).

The coating layer of the zinc oxide composite particles may have a surface treatment agent layer on the outermost layer.

Examples of the surface treatment agent constituting the surface treatment agent layer include the same ones as those mentioned in the description of the titanium oxide composite particles.

When the surface treatment agent layer is provided, a proportion of the surface treatment agent layer in the zinc oxide composite particles is preferably from 1 to 5% by mass, and more preferably from 1.5 to 4% by mass with respect to the total mass of the zinc oxide composite particles before providing the surface treatment agent layer, that is, the total mass of particles (inorganic particles) composed of an inorganic component such as zinc oxide or silicon oxide. When the proportion is 1% by mass or more, the effect of providing the surface treatment agent layer can be sufficiently obtained. When the proportion is 5% by mass or less, generation of a thermal decomposition product of the surface treatment agent is effectively suppressed during film molding.

As the zinc oxide composite particles, those produced by a known production method may be used, or commercially available products may be used.

The zinc oxide composite particles are obtained, for example, by a method of coating zinc oxide particles having a surface area of from 25 to 50 m²/g with silicon oxide. Examples of the method of coating with silicon oxide include a method using a sol-gel reaction using alkoxysilane, a method of producing from water glass (for example, Japanese Patent Application Laid-Open (JP-A) No. H11-256133), and the like.

Examples of a commercially available product that can be used as the zinc oxide composite particles include MZ-510HPSX (ZnO/SiO₂=83/17) manufactured by TAYCA CORPORATION. These commercially available products include those subjected to a hydrophobic treatment, but a surface treatment agent layer may be further provided.

When the titanium oxide composite particles and the zinc oxide composite particles are contained, a total content amount of the titanium oxide composite particles and the zinc oxide composite particles in the fluororesin layer is preferably from 1.0 to 15.0% by mass, and more preferably from 2.0 to 13.0% by mass. The content amount of the zinc oxide composite particles is preferably from 0.05 to 0.5% by mass, and more preferably from 0.1 to 0.3% by mass with respect to the fluororesin.

When the content amount of the zinc oxide composite particles is 0.05% by mass or more with respect to the fluororesin, hydrofluoric acid generated by decomposition of the fluororesin in the process of exposing the fluororesin layer to light can be sufficiently neutralized.

When the content amount of the zinc oxide composite particles is 0.5% by mass or less with respect to the fluororesin, the content amount of silicon oxide is sufficiently reduced, and accordingly, foamed streaks are less likely to occur during film molding, and a fluororesin layer having a good appearance is easily obtained.

The content amount of each component in the zinc oxide composite particles can be measured by using a scanning fluorescent X-ray analyzer (for example, ZSX Primus II manufactured by Rigaku Corporation). The content amount of each component may be measured using a press sheet of zinc oxide composite particles.

An average particle diameter of the zinc oxide composite particles is preferably from 0.1 to 5 μm, and more preferably from 0.2 to 2 μm. When the average particle diameter is 0.1 μm or more, the use of the surface hydrophobizing agent can be effectively suppressed, and the occurrence of streak defects during film molding can be effectively suppressed. When the average particle diameter is 5 μm or less, the surface smoothness of the film is excellent.

As a method of measuring the average particle diameter of zinc oxide composite particles, the average particle diameter is a value obtained by observing a fluororesin layer with a scanning electron microscope, measuring the particle diameters of 20 particles randomly extracted, and averaging the particle diameters.

### (Other Components)

The fluororesin layer according to one aspect of the disclosure may contain additives other than the fluororesin and the pigment as necessary. Examples of other additives include copper compounds such as copper oxide and copper iodide, hydrophobizing agents, antioxidants, mica, and antibacterial agents.

Among the above, inclusion of a copper compound improves the heat resistance of the resin film.

Examples of the hydrophobizing agent and the antioxidant include those similar to those mentioned as the surface treatment agent in the description of the titanium oxide composite particles.

The fluororesin layer according to one aspect of the disclosure can be produced, for example, by melt-kneading a fluororesin, a pigment, and other optional components by a known method to form a resin composition, and forming the resin composition into a film shape by a known molding method. Furthermore, a surface treatment may be performed as necessary.

The surface of the fluororesin layer in contact with the adhesive layer is preferably surface-treated in order to enhance the coatability of the adhesive layer. The surface treatment is not particularly limited, and examples thereof include a corona discharge treatment, a plasma discharge treatment, a UV ozone treatment, a flame treatment, and a chemical conversion treatment. Among them, corona discharge treatment or plasma discharge treatment is preferable, and corona discharge treatment is more preferable from the viewpoint of simplicity of the apparatus and ease of introduction of an industrial process. When corona discharge treatment or plasma discharge treatment is performed, a hydrophilic functional group is generated on the surface, and the surface energy is reduced.

The surface wetting index of the fluororesin layer by surface treatment is preferably 20 mN/m or more, more preferably 30 mN/m or more, and particularly preferably 35 mN/m or more from the viewpoint of the coatability of the adhesive layer and the adhesiveness between the adhesive layer and the fluororesin layer. The upper limit of the wet tension is not particularly limited, and may be 80 mN/m or less.

The surface wetting index of the fluororesin layer of the disclosure is a value obtained by subjecting at least one surface of the fluororesin layer to a corona treatment, and measuring the surface subjected to the corona treatment in accordance with JIS K6768:1999 using a wetting index reagent manufactured by FUJIFILM Wako Pure Chemical Corporation.

### [Adhesive Layer]

The adhesive layer according to one aspect of the disclosure is disposed on at least a part of the fluororesin layer and contains a silane coupling agent having a functional group.

As the silane coupling agent having a functional group, a known silane coupling agent can be used. Examples of the functional group include an amino group, an epoxy group, a mercapto group, an isocyanate group, and an acrylic group, and a silane coupling agent having at least one selected from the group consisting of an amino group, an epoxy group, and an acrylic group is preferable from the viewpoint of easily forming a bond at the interface between the substrate and the adhesive layer and excellent adhesiveness between the substrate and the adhesive layer, and a silane coupling agent having an amino group as a functional group is particularly preferable from the viewpoint of requiring heating in the bonding step with the substrate and excellent adhesiveness with a substrate having unevenness. One type of the silane coupling agent having a functional group may be used alone, or two or more types thereof may be used in combination.

As examples of silane coupling agents having an amino group, N-(2-aminoethyl)-3-aminopropylmethyldimethoxysilane, N-(2-aminoethyl)-3-aminopropyltrimethoxysilane, N-(2-aminoethyl)-3-aminopropylmethyldiethoxysilane, N-(2-aminoethyl)-3-aminopropyltriethoxysilane, 3-aminopropyltrimethoxysilane, 3-aminopropyltriethoxysilane, 3-aminopropylmethyldimethoxysilane, 3-aminopropylmethyldiethoxysilane, N-phenyl-3-aminopropyltrimethoxysilane, N-phenyl-3-aminopropyltriethoxysilane, N-phenyl-3-aminopropylmethyldimethoxysilane, and N-phenyl-3-aminopropylmethyldiethoxysilane are preferable. From the viewpoint of obtaining stable adhesive strength, 3-aminopropyltrimethoxysilane, 3-aminopropyltriethoxysilane, and 3-aminopropylmethyldimethoxysilane are particularly preferable.

As the silane coupling agent having an epoxy group, 3-glycidoxypropylmethyldimethoxysilane, 3-glycidoxypropyltrimethoxysilane, 3-glycidoxypropylmethyldiethoxysilane, and 3-glycidoxypropyltriethoxysilane are preferable.

As the silane coupling agent having a mercapto group, 3-mercaptopropylmethyldimethoxysilane, 3-mercaptopropyltrimethoxysilane, 3-mercaptopropylmethyldiethoxysilane, and 3-mercaptopropyltriethoxysilane are preferable.

As the silane coupling agent having an isocyanate group, 3-isocyanatopropylmethyldimethoxysilane, 3-isocyanatopropyltrimethoxysilane, 3-isocyanatopropylmethyldiethoxysilane, and 3-isocyanatopropyltriethoxysilane are preferable.

As the silane coupling agent having an acrylic group, 3-acryloxypropyltrimethoxysilane and 3-acryloxypropyltriethoxysilane are preferable.

An amount of the functional group of the silane coupling agent contained in the adhesive layer is preferably 0.01 mmol/m² or more, more preferably 0.015 mmol/m² or more, and still more preferably 0.05 mmol/m² or more. The upper limit value is preferably 5.0 mmol/m² or less, more preferably 2.5 mmol/m² or less, still more preferably 1.0 mmol/m² or less, particularly preferably 0.7 mmol/m² or less, and most preferably 0.2 mmol/m² or less.

A case where the amount of the functional group of the silane coupling agent contained in the adhesive layer is 0.01 mmol/m² or more is preferable from the viewpoint of excellent initial adhesiveness to the substrate and adhesiveness after a weather resistance test. When the amount is 5.0 mmol/m² or less, an unnecessary increase in the amount of the silane coupling agent used is suppressed.

In particular, when the amount of the functional group of the silane coupling agent contained in the adhesive layer is 1.0 mmol/m² or less, the hydrophilicity is retained for 100 days or more in the hydrophilicity retention evaluation at 80° C., and the adhesive layer is particularly excellent in outdoor use.

The amount of the functional group of the silane coupling agent contained in the adhesive layer is determined from the following theoretical value.

Theoretical value: When a coating solution containing a silane coupling agent (solid content) is applied with a bar coater and dried to form an adhesive layer, the theoretical value is obtained by dividing the numerical value obtained by multiplying the wire number of the bar coater by 2.29 and the concentration (=mass of the silane coupling agent/mass of the coating solution) by the molecular weight of the silane coupling agent.

An average thickness of the adhesive layer is preferably 0.5 μm or less, more preferably 0.1 μm or less, and still more preferably 0.05 or less. The lower limit value is preferably 0.001 μm or more, more preferably 0.003 μm or more, and still more preferably 0.01 μm or more. Within the above range, a stable adhesive strength can be obtained, which is preferable.

When a coating solution containing a silane coupling agent (solid content) is applied with a bar coater and dried to form an adhesive layer, the average thickness (μm) of the adhesive layer is obtained by multiplying the wire number of the bar coater by 2.29 and the concentration (=mass of the silane coupling agent/mass of the coating solution), and dividing the result by the specific gravity of the silane coupling agent.

The adhesive layer may further contain a leveling agent, a solvent, or the like in addition to the silane coupling agent having a functional group. A solvent that serves to dilute a silane coupling agent having a functional group to improve coatability when forming the adhesive layer is usually removed by drying, but may remain in the adhesive layer.

As the solvent, any solvent may be used as long as the solvent can dissolve or disperse the silane coupling agent having a functional group. Examples thereof include: aromatic hydrocarbons such as benzene, toluene, and xylene; alicyclic hydrocarbons such as cyclohexane; aliphatic hydrocarbons such as hexane and octane; ethers, ketones, and esters such as diacetone alcohol, diethylene glycol, butyl carbitol, isophorone, acetone, methyl ethyl ketone, methyl isobutyl ketone, cyclohexanone, 4-hydroxy-4-methyl-2-pentanone, and ethyl acetate; halogenated hydrocarbons such as dichloromethane and carbon tetrachloride; organic solvents containing two or more functional groups such as dimethylformamide, butyl carbitol acetate, and diethanolamine; and monohydric or polyhydric alcohols such as methanol, ethanol, propanol, 2-propanol, butanol, 2-methyl-1-propanol, and ethylene glycol. One type of the solvent may be used alone, or two or more types thereof may be used in combination.

The adhesive layer may be formed by applying an adhesive liquid containing a silane coupling agent having a functional group, a solvent, a leveling agent, and further any other component as a coating liquid. The coating liquid may be a dispersion liquid or a solution. The content amount of the solvent in the coating liquid is set to obtain viscosity suitable for a layer forming method to be applied, such as coating and printing. Usually, the solvent is contained in an amount of from 10 to 100 parts by mass with respect to 10 parts by mass of the silane coupling agent having a functional group, but is not limited thereto. The leveling agent is contained in an amount of from 0.01 to 0.10 parts by mass with respect to 10 parts by mass of the silane coupling agent having a functional group, but is not limited thereto. The content amount of other components optionally contained is also appropriately adjusted.

Examples of the adhesive liquid coating method of forming the adhesive layer include wet coating. Examples of the wet coating include a spin coating method, a bar coating method, a micro-gravure coating method, and direct gravure coating. Among them, a spin coating method, a bar coating method, and a micro-gravure coating method capable of coating with a small amount are preferable.

### [Layer Structure]

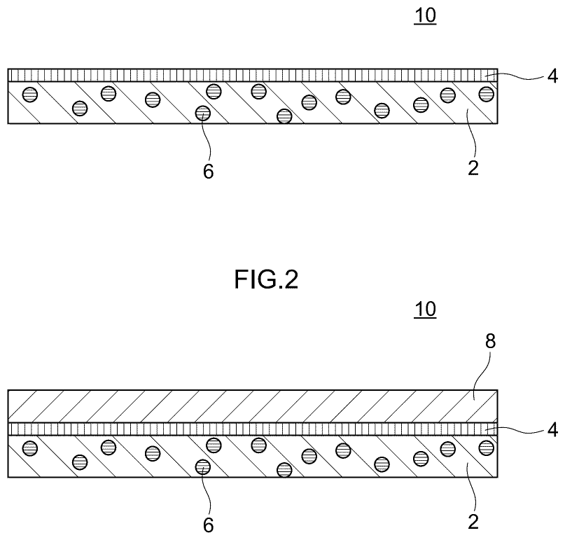

FIG. 1 is a schematic cross-sectional view showing a layer structure of an example of an adhesive film of the disclosure.

An adhesive film (10) of FIG. 1 is provided with a fluororesin layer (2) and an adhesive layer (4) in this order. The fluororesin layer (2) contains a pigment (6).

An average thickness of the adhesive film according to one aspect of the disclosure is preferably 10 μm or more, more preferably 12 μm or more, and still more preferably 20 μm or more. The upper limit value is preferably 300 μm or less, and more preferably 250 μm or less. Within the above range, followability to the substrate during lamination processing is excellent. The average thickness of the adhesive film is a value given as an arithmetic average value of thicknesses measured at five points. When the measurement can be performed with a micrometer, the measurement may be performed at five positions with a micrometer, and the average value thereof may be calculated. When the measurement cannot be performed with a micrometer, the adhesive film may be cut, the cross section thereof may be observed with a metallurgical microscope, an electron microscope, or the like, the measurement is performed at the five positions from comparison with a scale bar or the like, and the average value thereof may be calculated.

### (Other Layers)

The adhesive film may include an antifouling layer as another layer on the surface of the fluororesin layer not including the adhesive layer. Examples of the antifouling layer include a water-repellent layer, an oil-repellent layer, a fingerprint preventing layer, and a hydrophilic layer. In particular, the hydrophilic layer is preferable.

The hydrophilic layer as the antifouling layer can be formed by applying a hydrophilizing agent. The hydrophilizing agent is not particularly limited, and a known hydrophilizing agent can be used. As the hydrophilizing agent, for example, one containing hydrophilic inorganic fine particles (average particle diameter: approximately 0.01 μm) such as silica fine particles and alumina fine particles is preferable, and a mixture of silica fine particles and boehmite fine particles is more preferable. As the hydrophilizing agent, one obtained by dispersing inorganic fine particles in a silane coupling agent or a binder such as polyvinyl alcohol (PVA) is generally used. The hydrophilizing drop agent may include a solvent such as ion-exchanged water. A pH adjusting agent such as nitric acid may be contained.

A thickness of the hydrophilic layer is preferably from 0.01 to 1 μm.

When an antifouling layer is provided, it is preferable to surface-treat a substrate coated with a hydrophilizing agent in order to enhance the coatability of the hydrophilizing agent. The surface treatment is not particularly limited, and examples thereof include a corona discharge treatment, a plasma discharge treatment, an ozone treatment, a flame treatment, a chemical conversion treatment, and a primer treatment. As the surface treatment, corona discharge treatment is more preferable.

The primer treatment may be performed using a primer treatment solution. The primer treatment solution preferably contains an aminosilane. The primer treatment solution may further contain a leveling agent, a solvent, and the like.

### [Physical Properties and Like of Adhesive Film]

In the adhesive film according to one aspect of the disclosure, a transmittance at a wavelength of 360 nm is preferably 1.0% or less, more preferably 0.5% or less, more preferably 0.1% or less, and still more preferably 0.03% or less in order to shield ultraviolet rays and improve the adhesive strength with a substrate after a weather resistance test.

The transmittance at a wavelength of 360 nm may be 0.0%.

From the viewpoint of suppressing deterioration due to ultraviolet rays, a transmittance at a wavelength of 400 nm is preferably 1.0% or less, more preferably 0.4% or less, still more preferably 0.3% or less, and particularly preferably 0.1% or less.

The transmittance at a wavelength of 400 nm may be 0.0%.

Furthermore, a transmittance at a wavelength of 550 nm is preferably 10.0% or less, and more preferably 8.0% or less, from the viewpoint that the obtained adhesive film is excellent in the effect of hiding the substrate.

The transmittance at a wavelength of 550 nm may be 0.0%.

For the transmittance at each wavelength, transmittances (%) at 360 nm, 400 nm and 550 nm are measured in accordance with DIN EN410 1998 using an ultraviolet-visible-near-infrared spectrophotometer (for example, UV-PC3600 measuring instrument manufactured by Shimadzu Corporation).

In the adhesive film according to one aspect of the disclosure, an uneven structure may be imparted to at least one surface of the fluororesin layer. A case where an uneven structure is imparted to the surface of the fluororesin layer in contact with the adhesive layer, is preferable from the viewpoint that the surface area is increased and adhesiveness to the substrate is excellent. A case where an uneven structure is imparted to the surface of the fluororesin layer on which adhesive layer is not provided, is preferable from the viewpoint of excellent suppression of light reflection.

An arithmetic mean roughness Ra of the surface having the uneven structure is preferably from 0.3 to 3.5 μm, more preferably from 0.3 to 3.0 μm, still more preferably from 0.8 to 3.0 μm, particularly preferably from 1.0 to 3.0 μm, and may be from 1.0 to 2.5 μm. Further, the depth of the unevenness may be set shallower. In this case, Ra is preferably from 0.3 to 2.0 μm, more preferably from 0.8 to 1.8 μm, and still more preferably from 1.0 to 1.6 μm. On the other hand, the depth of the unevenness may be set to be deep. In this case, Ra is preferably from 0.6 to 3.0 μm, more preferably from 1.7 to 3.0 μm, and still more preferably from 1.8 to 3.0 μm.

A maximum height roughness Rz of the surface having the uneven structure is preferably from 1 to 25 μm, more preferably from 4 to 25 μm, and still more preferably from 4 to 22 μm. When the depth of the unevenness is set to be shallow, Rz is preferably from 1 to 8 μm, more preferably from 4 to 7 μm, and still more preferably from 4 to 6 μm. When the depth of the unevenness is set to be deep, Rz is preferably from 12 to 25 μm, more preferably from 13 to 25 μm, still more preferably from 14 to 22 μm, and may be from 15 to 25 μm or from 18 to 22 μm.

The arithmetic mean roughness Ra and the maximum height roughness Rz are values measured by a method described in JIS B0601:2013 (ISO4287:1997, Amd. 1:2009).

The adhesive film of the disclosure is excellent in adhesiveness after a weather resistance test, and therefore is suitably used as a protective film used outdoors. Examples of the protective film used outdoors include architectural exterior materials, solar cells, wind power generation blades, exterior materials for vehicles, exterior materials for ships, exterior materials for aerospace mobile bodies such as rockets and balloons, and communication infrastructure. In addition, since the adhesive film of the disclosure contains a pigment and is colored, it can also be utilized as a building interior material, an interior material of an aerospace mobile body such as a rocket and a balloon, and the like from the viewpoint of designability.

### <Article>

An article according to one aspect of the disclosure includes the adhesive film according to one aspect of the disclosure and a substrate, and includes a fluororesin layer, an adhesive layer, and a substrate in this order.

FIG. 2 is a schematic cross-sectional view showing a layer structure of an example of an article of the disclosure.

An article (20) of FIG. 2 is provided with the fluororesin layer (2), the adhesive layer (4), and a substrate (8) in this order. The fluororesin layer (2) contains a pigment (6). Another substrate (not shown) may be provided on a surface of the substrate (8) opposite to the adhesive layer (4).

The material (containing composition) constituting the substrate is not particularly limited, and a known material can be used. As examples of materials used for the substrate, there may be mentioned glass, polymethylpentene, syndiotactic polystyrene, polycycloolefin, silicone rubber, polyester elastomer, polyethylene terephthalate, polybutylene terephthalate, non-oriented nylon, polycarbonate, polyvinyl chloride, epoxy resin, acrylic resin, ethylene-vinyl acetate copolymer resin, modified polyethylene, and fiber-containing resin. From the viewpoint of a substrate having heat resistance such that deformation does not occur during thermal bonding with an adhesive film, glass, polycarbonate, polyvinyl chloride, epoxy resin, acrylic resin, ethylene-vinyl acetate copolymer resin, modified polyethylene, and fiber-containing resin are preferable, and from the viewpoints of high strength, light weight, corrosion resistance, and capability of being molded in both large and small sizes, fiber-containing resin is particularly preferable.

One type of these substrates may be used alone, or two or more types thereof may be used in combination.

Examples of the fibers contained in the fiber-containing resin include glass fibers, carbon fibers, and the like, boron fibers, aramid fibers, and the like. Examples of the resin used for the fiber-containing resin include thermosetting resins such as epoxy resins, phenol resins, and unsaturated polyester resins, and thermoplastic resins such as polypropylene resins and polyamide resins. In particular, as the substrate, glass fiber reinforced plastic (GFRP) which is a fiber-containing resin using glass fibers, thermosetting carbon fiber reinforced plastic (CFRP) which uses carbon fibers and a thermosetting resin such as an epoxy resin, and thermoplastic carbon fiber reinforced plastic (CFRTP) which uses carbon fibers and a thermoplastic resin such as a polypropylene resin are preferable.

Since the fiber-containing resin is lightweight and excellent in high elastic modulus, heat resistance, impact resistance, and the like, the fiber-containing resin is suitably used as a substrate for outdoor use or a substrate for an aircraft or the like as a structural material.

The adhesive film according to one aspect of the disclosure is also suitably used for a fiber-containing resin because the adhesive film is excellent in initial adhesiveness and adhesiveness after a weather resistance test when desired to be bonded to a substrate.

An average thickness of the substrate is not particularly limited, and is selected according to various applications.

When the average thickness of the substrate can be measured with a micrometer, the average value may be calculated by measuring the average thickness at five positions with a micrometer, or the average value may be calculated by cutting an article, observing a cross section thereof with a metallurgical microscope, an electron microscope, or the like, measuring the average thickness at five positions from comparison with a scale bar or the like. In the disclosure, measurement was performed in accordance with ISO 4591:1992 (Method B1 of JIS K7130:1999, a method of measuring thickness by the mass method of a sample taken from a plastic film or sheet).

In laminating the substrate and the adhesive film, a surface in contact with the adhesive layer may be surface-treated for the purpose of improving the adhesive strength between the adhesive layer and the substrate. The surface treatment is not particularly limited, and examples thereof include a corona discharge treatment, a plasma discharge treatment, a UV ozone treatment, a flame treatment, a chemical conversion treatment, and a primer treatment. A preferable surface treatment method is selected according to the type of the substrate, but from the viewpoint of ease of introduction of an industrial process, corona discharge treatment or plasma discharge treatment is preferable, and corona discharge treatment is more preferable.

A surface wetting index of the substrate obtained by performing the surface treatment is preferably 30 mN/m or more, more preferably 36 mN/m or more, and particularly preferably 40 mN/m or more. The upper limit of the wet tension is not particularly limited, and may be 60 mN/m or less.

A method of laminating the substrate and the adhesive film to produce an article is not particularly limited, and a known method can be adopted. For example, a lamination method using a hand roller in a normal temperature/normal pressure state, a method of laminating by heating and pressurizing in a vacuum state, and the like can be mentioned. When air bubbles enter between the adhesive film and the substrate at the time of lamination, it is preferable to remove the air bubbles by a hand roller, a brush, or a vacuum state since the adhesive strength decreases or the strength of the article decreases.

For the adhesive strength at the interface between the adhesive film and the substrate in the article of the disclosure, a peeling test was performed by a 180° peeling method at 50 mm/min under the condition of 180° C. using a Tensilon universal material testing machine (RTC-1210A manufactured by A&D Company, Limited). After the start of the test, the average value of the peel strength at 20 mm for a movement distance of from 10 to 30 mm is calculated as the adhesive strength.

A initial adhesive strength of the interface between the adhesive film and the substrate is preferably 3 N/cm or more, more preferably 6 N/cm or more, and still more preferably 10 N/cm or more. Also after a weather resistance test, the adhesive strength at the interface between the adhesive film and the substrate is preferably retained at 3 N/cm or more, and more preferably retained at 6 N/cm or more.

### (Other Layers)

The article may include an antifouling layer as another layer on a surface not in contact with the adhesive layer of the article. Examples of the antifouling layer include a water-repellent layer, an oil-repellent layer, a fingerprint preventing layer, and a hydrophilic layer. In particular, the hydrophilic layer is preferable.

Examples of the hydrophilic layer as the antifouling layer include those described above.

Since the article of the disclosure includes an adhesive film excellent in adhesiveness after a weather resistance test, the adhesive film is suitably used as a protective film for an article used outdoors. Examples of articles used outdoors include architectural exterior materials, solar cells, wind power generation blades, exterior materials for vehicles, exterior materials for ships, exterior materials for aerospace mobile bodies such as rockets and balloons, and communication infrastructure. In addition, since the article of the disclosure contains a pigment and has a colored adhesive film, it can also be utilized as a building interior material, an interior material of an aerospace mobile body such as a rocket and a balloon, and the like from the viewpoint of designability.

### EXAMPLES

Hereinafter, the invention will be described in detail with reference to Examples and Comparative Examples, but the invention is not limited to these Examples.

Of Examples 1 to 17, Examples 1 to 5, Example 11, and Examples 13 to 17 are examples, and Examples 6 to 10 and Example 12 are comparative examples.

The evaluation methods and materials used in each example are shown below.

### [Evaluation Method]

### (Thickness)

The average thickness (μm) of the fluororesin layer was measured in accordance with ISO 4591:1992 (Method B1 of JIS K7130:1999, a method of measuring thickness by the mass method of a sample taken from a plastic film or sheet).

When a coating solution containing a silane coupling agent (solid content) is applied with a bar coater and dried to form an adhesive layer, the average thickness (μm) of the adhesive layer was obtained by multiplying the wire number of the bar coater by 2.29 and the concentration (=mass of silane coupling agent/mass of coating solution) and dividing the result by a specific gravity of the silane coupling agent.

### (Transmittance (%))

The transmittance (%) at 360 nm, 400 nm and 550 nm of the test specimen of the adhesive film immediately after production was measured in accordance with DIN EN410 1998 using an ultraviolet/visible/near-infrared spectrophotometer (UV-PC3600 measuring instrument manufactured by Shimadzu Corporation).

### (Adhesive Strength (N/cm))

The obtained test specimen of the article was cut into a width of 10 mm to prepare an evaluation sample. This evaluation sample was subjected to a peeling test by a 180° peeling method at 50 mm/min under the condition of 180° C. using a Tensilon universal material testing machine (RTC-1210 A manufactured by A&D Company, Limited). After the start of the test, the average value of the peel strength at 20 mm within the 10 to 30 mm movement distance was calculated as the adhesive strength.

The evaluation criteria of the adhesive strength are as follows.
A (good): 6 N/cm or more
B (acceptable): 3 N/cm or more and less than 6 N/cm
C (poor): less than 3 N/cm

### (Weather Resistance Test)

The obtained test specimen of the article was cut into a size of 15 cm×7 cm to prepare an evaluation sample. This evaluation sample was placed in a weather resistance acceleration test device (Eye Super UV Tester manufactured by Iwasaki Electric), and exposed for 500 hours by repeating the following cycle (one cycle is 12 hours and 20 seconds) while irradiating ultraviolet rays having a wavelength of 300 to 450 nm and an intensity of 1500 mW/cm²: (i) irradiation with ultraviolet rays for 10 hours under the conditions of a BP (black panel) temperature of 63° C. and a relative humidity of 50% RH, (ii) shower for 10 seconds, (iii) dark dew condensation state for 2 hours under the conditions of a BP temperature of 30° C. and a relative humidity of 100% RH, and (iv) shower for 10 seconds. Ultraviolet irradiation of the test specimen was performed from the fluororesin layer side.

For the evaluation samples after exposure, the adhesive strength was measured in the same manner as described above. The evaluation criteria of the adhesive strength are also the same as described above.

### (Hydrophilicity Retention Test)

An adhesive film with a hydrophilic layer in which a hydrophilic layer was provided on an adhesive layer of the adhesive film was prepared. An evaluation sample of 14 cm long×8 cm wide was cut out from the adhesive film with a hydrophilic layer. A stainless steel (SUS) roof frame was installed with an inclination of 15 degrees with respect to a horizontal plane with an environmental test chamber at a constant temperature of 20° C. and a constant temperature water bath at 80° C., and the evaluation sample was set on the frame with the hydrophilic layer facing downward and left for 100 days at the maximum, then the evaluation sample was removed. The evaluation sample was removed at 1 day, 10 days, and 100 days after setting, and the state of water droplets on the surface of the hydrophilic layer was observed for the sample to confirm the hydrophilic retention force.

The criteria for determining whether hydrophilicity is retained are as follows.

Hydrophilicity is retained: water droplets spread in a film shape on the surface of the hydrophilic layer and flowed down.

Hydrophilicity was not retained: water droplets remained in a ball shape on the surface of the hydrophilic layer and did not flow down.

The hydrophilic layer was prepared using a hydrophilizing agent obtained by mixing the following liquid 1 and liquid 2.

Liquid 1:1.5 parts by mass of 1 N nitric acid was added to 16.1 parts by mass of ion-exchanged water, 9.7 parts by mass of silica sol (Product name: “SNOWTEX (registered trademark) S”, manufactured by Nissan Chemical Corporation, pH 10, solid content concentration: 30% by mass) was added with stirring, stirring was continued for 30 minutes, and then the mixture was allowed to stand at room temperature (25° C.) for 1 day.

Liquid 2:2 parts by mass of 1 N nitric acid was added to 2.75 parts by mass of ion-exchanged water, 50 parts by mass of industrial ethanol (Product name: “Solmix AP-1”, manufactured by Nippon Alcohol Trading Co., Ltd.), 17.8 parts by mass of boehmite (Product name: “K-Statch Z20A”, manufactured by K.I Chemical Industry Co., Ltd., pH 4.0, solid concentration: 20% by mass), and 0.2 parts by mass of aminosilane (Product name “KBM903”, manufactured by Shin-Etsu Chemical Co., Ltd.) were added with stirring, stirring was continued for 30 minutes, and then the mixture was allowed to stand at room temperature (25° C.) for 1 day.

The obtained hydrophilizing agent was applied by a bar coating method using a No. 5 bar coater, and dried at 80° C. for 60 seconds to form a layer having a thickness of 0.3 μm, thereby obtaining a film with a hydrophilizing agent.

Evaluation criteria of the hydrophilicity retention test are as follows.
A (good): Hydrophilicity was retained for 100 days or more.
B (acceptable): The period during which hydrophilicity was retained was 10 days or more and less than 100 days.
C (poor): The period during which hydrophilicity was retained was less than 10 days.

### Materials Used

### (Pigment)

### (Production of b1)

100 parts by mass of titanium oxide composite particles (the average particle diameter is 0.25 μm, in the titanium oxide composite particles, the ratio of titanium oxide is 96.7% by mass, the proportion of aluminum oxide is 1.4% by mass, the ratio of the total amount of silicon oxide, zirconium oxide, and cerium oxide is 1.9% by mass, the proportion of the total amount of phosphorus oxide and aluminum oxide is 1.6% by mass, and the proportion of the coating layer is 3.3% by mass) having a coating layer containing aluminum oxide on the surface of titanium oxide, Ti-Pure (registered trademark) R-350 (manufactured by Chemours Company) was added to a solution in which 2 parts by mass of dimethyl silicone oil (Product name “SH 200”, manufactured by Dow Corning Toray Co., Ltd.) was dispersed in isopropyl alcohol, mixed, and baked at 140° C. for 2 hours to obtain a pigment (b1).

### (Production of b2)

According to the description of JP-A No. H11-256133, a pigment (b2) of silica-coated zinc oxide particles containing 60% by mass of zinc oxide and 40% by mass of silica was produced.

### Example 1

As the fluororesin, Fluon (registered trademark) C-88AX (ETFE resin, manufactured by AGC Inc.) was used.

100 parts by mass of Fluon C-88AX and 9.05 parts by mass of the pigment (b1) were blended, and then extruded at a temperature of 320° C. and a discharge amount of 20 kg per 1 hour with a 35 mm unidirectional twin-screw kneading extruder (TEM35: manufactured by Toshiba Machine Co., Ltd.) to obtain titanium oxide-containing pellets. The content of the pigment (b1) contained in the fluororesin layer was 8.3% by mass.

The titanium oxide-containing pellets were dried at 150° C. for 1 hour, and then extruded into a film shape to form a fluororesin layer having an average thickness of 75 μm. The film discharged from the T-die was passed while nipping between a mirror surface roll retained at 150° C. and a surface embossing roll retained at 100° C. Thereafter, both surfaces were subjected to a surface treatment by corona discharge to obtain a fluororesin film having a surface wetting index of 40 mN/m and one surface having an uneven structure. The surface having the uneven structure had Ra of 2.8 μm and Rz of 14.8.

The surface wetting index in the disclosure is a value measured in accordance with JIS K6768:1999 using a wetting index reagent manufactured by FUJIFILM Wako Pure Chemical Corporation.

The transmittance of the obtained fluororesin film at a wavelength of 360 nm was 0.0%.

An adhesive liquid was applied to a surface having no uneven structure of a fluororesin film subjected to a corona discharge treatment by a bar coating method using a No. 5 bar, and the coated fluororesin film was dried at 80° C. for 5 seconds to form an adhesive layer having an average thickness of 0.34 μm and a coating amount of 0.34 g/m², thereby obtaining a test specimen of the adhesive film.

As the adhesive liquid, a solution containing 3% by mass of a silane coupling agent having a primary amino group as an organic functional group (Product name “KBM-903”, manufactured by Shin-Etsu Chemical Co., Ltd., 3-aminopropyltrimethoxysilane), 0.05% by mass of a leveling agent (Product name “Surfynol 420”, manufactured by Shin-Etsu Chemical Co., Ltd.), and 96.95% by mass of industrial ethanol (Product name: “Solmix AP-1”, manufactured by Nippon Alcohol Trading Co., Ltd.) was used.

The amount of the functional group of the silane coupling agent contained in the adhesive layer was 1.92 mmol/m².

The test specimen of the obtained adhesive film was cut out into a size of 15 cm×7 cm. A 40 cm square SUS plate, a 40 cm square 125 μm polyimide film (Product name “UPILEX (registered trademark)-S, product number 125S” manufactured by UBE Corporation), an adhesive film, a 220 μm uncured epoxy-based CFRP prepreg serving as a substrate (product name “TR3110 381GM” manufactured by Mitsubishi Rayon Co., Ltd.), and an SUS plate were laminated in this order, and placed on a table of a high temperature vacuum press machine (KVHC-2 manufactured by Kitagawa Seiki Co., Ltd.). When the adhesive film was laminated on the substrate, the article was disposed to include the fluororesin, the adhesive layer, and the substrate in this order. Then, the vacuum state (vacuum degree: 1.0 kPa) was set, and then pressing was performed at 180° C. for 90 minutes. Thereafter, the state was returned to the atmospheric pressure, it was confirmed that the sample temperature was 40° C. or lower, and the sample was taken out to obtain a test specimen of the article having a layer structure of fluororesin layer/adhesive layer/CFRP.

The above evaluation was conducted on the obtained test specimens of the adhesive film and the article. The results are shown in Table 2.

### Example 2

An adhesive layer was formed in the same manner as in Example 1 except that the amount of KBM-903 in the adhesive liquid was changed to 0.3% by mass and adjusted with the amount of ethanol to obtain a test specimen of the adhesive film and a test specimen of the article.

The adhesive layer in the adhesive film of Example 2 had an average thickness of 0.034 μm, and the functional group amount of the silane coupling agent contained in the adhesive layer was 0.19 mmol/m².

The test specimen of the adhesive film and the test specimen of the article of Example 2 were evaluated in the same manner as in Example 1. The results are shown in Table 2.

### Example 3

An adhesive layer was formed in the same manner as in Example 1 except that the amount of KBM-903 in the adhesive liquid was changed to 0.03% by mass and adjusted with the amount of ethanol to obtain a test specimen of the adhesive film and a test specimen of the article.

The adhesive layer in the adhesive film of Example 3 had an average thickness of 0.0034 μm, and the functional group amount of the silane coupling agent contained in the adhesive layer was 0.019 mmol/m².

The test specimen of the adhesive film and the test specimen of the article of Example 3 were evaluated in the same manner as in Example 1. The results are shown in Table 2.

### Example 4

Using the same method as in Example 1, titanium oxide-containing pellets were prepared such that the content of the pigment (b1) contained in the fluororesin layer was 3.0% by mass, thereby obtaining a fluororesin film having an average thickness of 200 μm with one surface having an uneven structure. The surface having the uneven structure had Ra of 3.0 μm and Rz of 16.8.

In addition, an adhesive layer was formed using the same method as in Example 1 except that the amount of KBM-903 in the adhesive liquid was changed to 1.0% by mass and adjusted with the amount of ethanol to obtain a test specimen of the adhesive film and a test specimen of the article.

The adhesive layer in the adhesive film of Example 4 had an average thickness of 0.11 μm, and the functional group amount of the silane coupling agent contained in the adhesive layer was 0.64 mmol/m².

The test specimen of the adhesive film and the test specimen of the article of Example 4 were evaluated in the same manner as in Example 1. The results are shown in Table 2.

### Example 5

Titanium oxide-containing pellets were prepared in the same manner as in Example 1 by blending 100 parts by mass of Fluon C-88AX, 3.1 parts by mass of the pigment (b1), and 0.21 parts by mass of the pigment (b2) to obtain a fluororesin film having an average thickness of 200 μm. The content of the pigment (b1) contained in the fluororesin was 3.0% by mass, and the content of the pigment (b2) was 0.2% by mass.

In addition, an adhesive layer was formed using the same method as in Example 1 except that the amount of KBM-903 in the adhesive liquid was changed to 0.3% by mass and adjusted with the amount of ethanol to obtain a test specimen of the adhesive film and a test specimen of the article.

The adhesive layer in the adhesive film of Example 5 had an average thickness of 0.034 μm, and the functional group amount of the silane coupling agent contained in the adhesive layer was 0.19 mmol/m².

The test specimen of the adhesive film and the test specimen of the article of Example 5 were evaluated in the same manner as in Example 1. The results are shown in Table 2.

### Example 6

Test specimens of the adhesive film and the test specimens of the article were obtained in the same manner as in Example 2 except that a fluororesin film (Trade name: “AFLEX 50N”, manufactured by AGC Inc.) of ETFE containing no pigment having an average thickness of 50 μm was used in place of the fluororesin film.

The test specimen of the adhesive film and the test specimen of the article of Example 6 were evaluated in the same manner as in Example 1. The results are shown in Table 2.

### Example 7

A fluororesin film (Trade name: “AFLEX 50N”, manufactured by AGC Inc.) of ETFE not containing a pigment having an average thickness of 50 μm was used in place of the fluororesin film of Example 1, and one surface of the fluororesin film was subjected to atmospheric pressure plasma discharge treatment at 300 W·min/m² in a mixed gas atmosphere composed of argon gas/ethylene gas/carbon dioxide gas=100/10/2 (molar ratio) in place of corona discharge treatment to obtain a fluororesin film having a surface wetting index of 44 mN/m.

The obtained fluororesin film was laminated on a substrate in the same manner as in Example 1 without forming an adhesive layer to obtain a test specimen of the article. At this time, the substrate was disposed such that the surface subjected to the atmospheric pressure plasma discharge treatment was in contact with the substrate.

The test specimen of the adhesive film and the test specimen of the article of Example 7 were evaluated in the same manner as in Example 1. The results are shown in Table 2.

### Example 8

A fluororesin film (Trade name: “AFLEX 50N”, manufactured by AGC Inc.) of ETFE having an average thickness of 50 μm was used in place of the fluororesin film of Example 1, and one surface thereof was subjected to surface treatment by corona discharge in the same manner as in Example 1 to obtain a fluororesin film having a surface wetting index of 50 mN/m.

The obtained fluororesin film was laminated on a substrate in the same manner as in Example 1 without forming an adhesive layer to obtain a test specimen of the article. At this time, the substrate was disposed such that the surface subjected to the corona discharge treatment was in contact with the substrate.

The test specimen of the adhesive film and the test specimen of the article of Example 8 were evaluated in the same manner as in Example 1. The results are shown in Table 2.

### Example 9

A fluororesin film (Trade name: “AFLEX 50N”, manufactured by AGC Inc.) of ETFE having an average thickness of 50 μm was used, and both surfaces thereof were subjected to surface treatment by corona discharge in the same manner as in Example 1 to obtain a fluororesin film having a surface wetting index of 40 mN/m.

On one surface that was subjected to surface treatment, the adhesive composition described below was applied with an applicator such that the thickness after drying would be 25 μm, and dried at 70° C. for 5 minutes to form an adhesive layer.

As the adhesive composition, one containing 100 parts by mass of SK-2094 (manufactured by Soken Chemical & Engineering Co., Ltd., solid content: 25% by mass), 1 part by mass of a crosslinking agent M-5A (manufactured by Soken Chemical & Engineering Co., Ltd., solid content: 100% by mass), 5 parts by mass of an ultraviolet absorber (product name “TINUVIN 479”, manufactured by BASF Japan Ltd.), and 1.5 parts by mass of a light stabilizer (product name “TINUVIN 123”, manufactured by BASF Japan Ltd.) was used.

CFRP as a substrate was superposed on the obtained adhesive layer, and the obtained laminate was pasted using a hand roller at room temperature such that air bubbles did not enter. As a result, a test specimen of the article having a layer structure of fluororesin layer/ultraviolet absorber-containing adhesive layer/CFRP was obtained.

The test specimen of the adhesive film and the test specimen of the article of Example 9 were evaluated in the same manner as in Example 1. The results are shown in Table 3.

### Example 10

A fluororesin film (Trade name: “AFLEX 50N”, manufactured by AGC Inc.) of ETFE having an average thickness of 50 μm was used, and both surfaces thereof were subjected to surface treatment by corona discharge in the same manner as in Example 1 to obtain a fluororesin film having a surface wetting index of 40 mN/m.

On one surface that was subjected to surface treatment, the adhesive composition described below was applied with an applicator such that the thickness after drying would be 10 μm, and dried at 70° C. for 5 minutes to form an adhesive layer.

The adhesive layer was prepared by mixing 100 parts by mass (solid content) of HD-1013 (product name “HD-1013”, solid content: 60% by mass, manufactured by Rock Paint Co., Ltd.), which is a polyurethane resin as the main component, 18.8 parts by mass (solid content) of H-62 (isocyanate content amount: 10% by mass, solid content: 75% by mass, manufactured by Rock Paint Co., Ltd.) as a curing agent, 7 parts by mass of TINUVIN 479 (a hydroxyphenyltriazine-based ultraviolet absorber, manufactured by BASF Japan Ltd.) as an ultraviolet absorber, and 1.5 parts by mass of TINUVIN 123 (a hindered amine-based light stabilizer, manufactured by BASF Japan Ltd.) as a light stabilizer to prepare an adhesive composition.

CFRP as a substrate was superposed on the obtained adhesive layer, and the obtained laminate was pasted using a hand roller at room temperature such that air bubbles did not enter. As a result, a test specimen of the article having a layer structure of fluororesin layer/ultraviolet absorber-containing adhesive layer/CFRP was obtained.

The test specimen of the adhesive film and the test specimen of the article of Example 10 were evaluated in the same manner as in Example 1. The results are shown in Table 3.

### Example 11

The adhesive film prepared in Example 2 was cut into a size of 15 cm×7 cm. A 50 cm square PTFE glass cloth, a 40 cm square tempered glass, a 50 cm square PTFE glass cloth, a 2 mm polycarbonate (PC) resin serving as the substrate (Product name: “PC-1600”, manufactured by Takiron CI Co., Ltd.), the adhesive film prepared in Example 2, and a 50 cm square PTFE glass cloth were laminated in this order and placed on the table of a vacuum laminator (LM-50S, manufactured by NPC Inc.) set to 120° C. When the adhesive film was laminated on the substrate, the article was disposed to include the fluororesin, the adhesive layer, and the substrate in this order.

Then, after preheating for 3 minutes under a vacuum condition (degree of vacuum: 100 Pa), pressure was applied at 100 Ps for 30 minutes, the state was returned to atmospheric pressure, it was confirmed that the sample temperature had returned to room temperature, and the sample was taken out to obtain a test specimen of the article having a layer structure of fluororesin layer/adhesive layer/polycarbonate resin.

The test specimens of the article of Example 11 were evaluated in the same manner as in Example 1. The results are shown in Table 3.

### Example 12

A test specimen of the article containing a polycarbonate (PC) resin as a substrate was obtained in the same manner as in Example 11 without forming an adhesive layer on the fluororesin film described in Example 1.

The test specimen of the adhesive film and the test specimen of the article of Example 12 were evaluated in the same manner as in Example 1. The results are shown in Table 3.

### Example 13

A test specimen of the article having a layer structure of fluororesin layer/adhesive layer/glass epoxy resin was obtained using the same method as in Example 11 except that the substrate was changed to a 2 mm glass epoxy (EG) resin (Product name “T-932”, manufactured by Sumitomo Bakelite Co., Ltd.) in place of the polycarbonate resin.

The test specimen of the article of Example 13 was evaluated in the same manner as in Example 1. The results are shown in Table 3.

### Example 14

A test specimen of the article having a layer structure of fluororesin layer/adhesive layer/polyvinyl chloride resin was obtained using the same method as in Example 11 except that the substrate was changed to a 2 mm polyvinyl chloride (PVC) resin (Product name “Sumilite (registered trademark) EL-3762”, manufactured by Takiron CI Co., Ltd.) in place of the polycarbonate resin. The surface in contact with the adhesive layer of the polyvinyl chloride resin was subjected to a corona discharge treatment with a surface wetting index of 50 mN/m.

The test specimens of the article of Example 14 were evaluated in the same manner as in Example 1. The results are shown in Table 3.

### Example 15

A test specimen of the article having a layer structure of fluororesin layer/adhesive layer/methacrylic resin was obtained using the same method as in Example 11 except that the substrate was changed to a 2 mm methacrylic (PMMA) resin (Product name “Acrylite (registered trademark) L #001”, manufactured by Mitsubishi Chemical Corporation) in place of the polycarbonate resin. The surface in contact with the adhesive layer of the methacrylic resin was subjected to a corona discharge treatment with a surface wetting index of 40 mN/m.

The test specimens of the article of Example 15 were evaluated in the same manner as in Example 1. The results are shown in Table 3.

### Example 16

A test specimen of the article having a layer structure of fluororesin layer/adhesive layer/glass was obtained using the same method as in Example 11 except that the substrate was changed to 3 mm glass (Product name “FL3”, manufactured by AGC Inc.) in place of the polycarbonate resin.

The test specimens of the article of Example 16 were evaluated in the same manner as in Example 1. The results are shown in Table 3.

### Example 17

The adhesive film prepared in Example 2 was cut into a size of 15 cm×8 cm. A 50 cm square PTFE glass cloth, a 40 cm square reinforced glass, a 50 cm square PTFE glass cloth, the adhesive film prepared in Example 2, a 450 μm ethylene-vinyl acetate (EVA) resin serving as the substrate (product name “F806”, manufactured by Foster Corporation), the atmospheric pressure plasma-treated fluororesin film prepared in Example 7, and a 50 cm square PTFE glass cloth were laminated in this order and placed on the table of a vacuum laminator (LM-50S, manufactured by NPC Inc.) set to 145° C. When the adhesive film was laminated on the substrate, the article was disposed to include the fluororesin, the adhesive layer, and the substrate in this order.

Then, after preheating for 3 minutes under a vacuum condition (degree of vacuum: 100 Pa), pressure was applied at 100 Ps for 15 minutes, the state was returned to atmospheric pressure, it was confirmed that the sample temperature had returned to room temperature, and the sample was taken out to obtain a test specimen of the article having a layer structure of fluororesin layer/adhesive layer/EVA resin/fluororesin film (atmospheric pressure plasma treated).

The test specimens of the article of Example 17 were evaluated in the same manner as in Example 1. In the evaluation of the adhesive strength, the interface between the fluororesin layer/adhesive layer and the EVA resin was measured. The results are shown in Table 3.

TABLE 2

| | | | Example 1 | Example 2 | Example 3 | Example 4 |
|---|---|---|---|---|---|---|
| Fluororesin | Substrate type | | ETFE | ETFE | ETFE | ETFE |
| layer | Average thickness [μm] | | 75 | 75 | 75 | 200 |
| | Pigment content | (b1) | 8.3 | 8.3 | 8.3 | 3.0 |
| | [% by mass] | (b2) | — | — | — | — |
| | Formula (1) | | 622.5 | 622.5 | 622.5 | 600 |
| | Pigment content [% by mass] × | | | | | |
| | average thickness [μm] | | | | | |
| | Transmittance | 360 nm | 0.0 | 0.0 | 0.0 | 0.0 |
| | [% T] | 400 nm | 0.1 | 0.1 | 0.1 | 0.4 |
| | | 550 nm | 7.5 | 7.5 | 7.5 | 9.4 |
| | Surface treatment | | Corona | Corona | Corona | Corona |
| Adhesive | Adhesive | | Aminosilane | Aminosilane | Aminosilane | Aminosilane |
| layer | | | coupling | coupling | coupling | coupling |
| | | | agent | agent | agent | agent |
| | Adhesive | Amount of silane | 3 | 0.3 | 0.03 | 1.0 |
| | liquid | coupling agent | | | | |
| | | [% by mass] | | | | |
| | Adhesive | Amount of functional | 0.34 | 0.034 | 0.0034 | 0.11 |
| | layer | group of silane coupling | | | | |
| | | agent [g/m²] | | | | |
| | | Amount of amino group | 1.92 | 0.19 | 0.019 | 0.64 |
| | | of silane coupling agent | | | | |
| | | [mmol/m²] | | | | |
| | | Average thickness [μm] | 0.34 | 0.034 | 0.0034 | 0.11 |
| Substrate | Type | | CFRP | CFRP | CFRP | CFRP |
| Evaluation | Initial | Adhesive strength | 13.5 | 11.2 | 9.1 | 13.5 |
| | | [N/cm] | | | | |
| | | Evaluation | A | A | A | A |
| | SUV after | Adhesive strength | 10.4 | 8.7 | 7.8 | 6.5 |
| | 500 hours | [N/cm] | | | | |
| | | Evaluation | A | A | A | A |
| | | | Example 5 | Example 6 | Example 7 | Example 8 |
| Fluororesin | Substrate type | | ETFE | ETFE | ETFE | ETFE |
| layer | Average thickness [μm] | | 200 | 50 | 50 | 50 |
| | Pigment content | (b1) | 3.0 | — | — | — |
| | [% by mass] | (b2) | 0.2 | — | — | — |
| | Formula (1) | | 600 | — | — | — |
| | Pigment content [% by mass] × | | | | | |
| | average thickness [μm] | | | | | |
| | Transmittance | 360 nm | 0.0 | 91.9 | 91.9 | 91.9 |
| | [% T] | 400 nm | 0.0 | 92.3 | 92.3 | 92.3 |
| | | 550 nm | 7.5 | 94.4 | 94.4 | 94.4 |
| | Surface treatment | | Corona | Corona | Atmospheric | Corona |
| | | | | | pressure | |
| | | | | | plasma | |
| Adhesive | Adhesive | | Aminosilane | Aminosilane | None | None |
| layer | | | coupling | coupling | | |
| | | | agent | agent | | |
| | Adhesive | Amount of silane | 0.3 | 0.3 | — | — |
| | liquid | coupling agent | | | | |
| | | [% by mass] | | | | |
| | Adhesive | Amount of functional | 0.0034 | 0.0034 | — | — |
| | layer | group of silane coupling | | | | |
| | | agent [g/m²] | | | | |
| | | Amount of amino group | 0.19 | 0.19 | — | — |
| | | of silane coupling agent | | | | |
| | | [mmol/m²] | | | | |
| | | Average thickness [μm] | 0.0034 | 0.0034 | — | — |
| Substrate | Type | | CFRP | CFRP | CFRP | CFRP |
| Evaluation | Initial | Adhesive strength | 13.5 | 11.3 | 9.1 | 6.9 |
| | | [N/cm] | | | | |
| | | Evaluation | A | A | A | A |
| | SUV after | Adhesive strength | 7.9 | 0.2 | 0.2 | 0.2 |
| | 500 hours | [N/cm] | | | | |
| | | Evaluation | A | C | C | C |

TABLE 3

| | | | Example 9 | Example 10 | Example 11 | Example 12 | Example 13 |
|---|---|---|---|---|---|---|---|
| Fluororesin | Type Substrate | | ETFE | ETFE | ETFE | ETFE | ETFE |
| layer | Average thickness [μm] | | 50 | 50 | 75 | 75 | 75 |
| | Pigment content | (b1) | — | — | 8.3 | 8.3 | 8.3 |
| | [% by mass] | (b2) | — | — | — | — | — |
| | Formula (1) | | — | — | 622.5 | 622.5 | 622.5 |
| | Pigment content [% by mass] × | | | | | | |
| | average thickness [μm] | | | | | | |
| | Transmittance | 360 nm | 0.5 | 4.5 | 0.0 | 0.0 | 0.0 |
| | [% T] | 400 nm | 43.6 | 84.5 | 0.1 | 0.1 | 0.1 |
| | | 550 nm | 91.5 | 92.6 | 7.5 | 7.5 | 7.5 |
| | Surface treatment | | Corona | Corona | Corona | Corona | Corona |
| Adhesive | Adhesive | | Ultraviolet | Ultraviolet | Aminosilane | None | Aminosilane |
| layer | | | absorbing | absorber- | coupling | | coupling |
| | | | material- | containing | agent | | agent |
| | | | containing | urethane resin | | | |
| | | | acrylic resin | | | | |
| | Adhesive liquid | Amount of silane | — | — | 0.3 | — | 0.3 |
| | | coupling agent | | | | | |
| | | [% by mass] | | | | | |
| | Adhesive layer | Amount of functional | — | — | 0.034 | — | 0.034 |
| | | group of silane coupling | | | | | |
| | | agent [g/m²] | | | | | |
| | | Amount of amino group | — | — | 0.19 | — | 0.19 |
| | | of silane coupling agent | | | | | |
| | | [mmol/m²] | | | | | |
| | | Average thickness [μm] | 25 | 5 | 0.034 | — | 0.034 |
| Substrate | Type | | CFRP | CFRP | PC | PC | EG |
| Evaluation | Initial | Adhesive strength | 5.6 | 5.7 | 5.1 | 0.2 | 6.0 |
| | | [N/cm] | | | | | |
| | | Evaluation | B | B | B | C | A |
| | SUV after 500 | Adhesive strength | 0.9 | 0.9 | 5.1 | — | 5.6 |
| | hours | [N/cm] | | | | | |
| | | Evaluation | C | C | B | — | B |

| | | | Example 14 | Example 15 | Example 16 | Example 17 |
|---|---|---|---|---|---|---|
| Fluororesin | Type Substrate | | ETFE | ETFE | ETFE | ETFE |
| layer | Average thickness [μm] | | 75 | 75 | 75 | 75 |
| | Pigment content | (b1) | 8.3 | 8.3 | 8.3 | 8.3 |
| | [% by mass] | (b2) | — | — | — | — |
| | Formula (1) | | 622.5 | 622.5 | 622.5 | 622.5 |
| | Pigment content [% by mass] × | | | | | |
| | average thickness [μm] | | | | | |
| | Transmittance | 360 nm | 0.0 | 0.0 | 0.0 | 0.0 |
| | [% T] | 400 nm | 0.1 | 0.1 | 0.1 | 0.1 |
| | | 550 nm | 7.5 | 7.5 | 7.5 | 7.5 |
| | Surface treatment | | Corona | Corona | Corona | Corona |
| Adhesive | Adhesive | | Aminosilane | Aminosilane | Aminosilane | Aminosilane |
| layer | | | coupling | coupling | coupling | coupling |
| | | | agent | agent | agent | agent |
| | Adhesive liquid | Amount of silane | 0.3 | 0.3 | 0.3 | 0.3 |
| | | coupling agent | | | | |
| | | [% by mass] | | | | |
| | Adhesive layer | Amount of functional | 0.034 | 0.034 | 0.034 | 0.034 |
| | | group of silane coupling | | | | |
| | | agent [g/m²] | | | | |
| | | Amount of amino group | 0.19 | 0.19 | 0.19 | 0.19 |
| | | of silane coupling agent | | | | |
| | | [mmol/m²] | | | | |
| | | Average thickness [μm] | 0.034 | 0.034 | 0.034 | 0.034 |
| Substrate | Type | | PVC | PMMA | Glass | EVA |
| Evaluation | Initial | Adhesive strength | 7.7 | 6.1 | 18.5 | 25.7 |
| | | [N/cm] | | | | |
| | | Evaluation | A | A | A | A |
| | SUV after 500 | Adhesive strength | 5.8 | 5.4 | 18.3 | 24.8 |
| | hours | [N/cm] | | | | |
| | | Evaluation | B | B | A | A |

The adhesive films of Examples 1 to 5, Example 11, and Examples 13 to 17 maintained sufficient adhesive strength to various substrates even after a weather resistance acceleration test for 500 hours. In particular, in the article using the adhesive film of Examples 1 to 5 and CFRP as a substrate, excellent adhesive strength was retained even after the weather resistance acceleration test for 500 hours. In addition, as in Example 5, the adhesive film in which zinc oxide was blended together with titanium oxide as a pigment also showed particularly excellent adhesiveness after a weather resistance acceleration test for 500 hours.

On the other hand, in the adhesive film in which the content of the pigment in the fluororesin was less than 1% by mass as in Examples 6 to 8, although the initial adhesive strength to the substrate was 3 N/cm or more, the adhesive strength to the substrate after a weather resistance acceleration test for 500 hours became less than 3 N/cm, and sufficient adhesive strength could not be retained. Also in the fluororesin films without the adhesive layer of the disclosure as in Examples 7 to 10, the initial adhesive strength with the substrate was 3 N/cm or more, but the adhesive strength with the substrate after a weather resistance acceleration test for 500 hours was less than 3 N/cm, and sufficient adhesive strength could not be retained. As in Example 12, it was found that the initial adhesive strength was also poor in the case of the fluororesin film having no adhesive layer of the disclosure depending on the type of substrate.

The results of evaluating the retention of hydrophilicity for Examples 1 to 5 are shown in Table 4.

TABLE 4

| | | | Example 1 | Example 2 | Example 3 | Example 4 | Example 5 |
|---|---|---|---|---|---|---|---|
| Fluororesin | Substrate type | | ETFE | ETFE | ETFE | ETFE | ETFE |
| layer | Average thickness [μm] | | 75 | 75 | 75 | 200 | 200 |
| | Pigment content | (b1) | 8.3 | 8.3 | 8.3 | 3.0 | 3.0 |
| | [% by mass] | (b2) | — | — | — | — | 0.2 |
| | Formula (1) | | 622.5 | 622.5 | 622.5 | 600 | 600 |
| | Pigment content [% by mass] × | | | | | | |
| | average thickness [μm] | | | | | | |
| | Transmittance | 360 nm | 0.0 | 0.0 | 0.0 | 0.0 | 0.0 |
| | [% T] | 400 nm | 0.1 | 0.1 | 0.1 | 0.4 | 0.0 |
| | | 550 nm | 7.5 | 7.5 | 7.5 | 9.4 | 7.5 |
| | Surface treatment | | Corona | Corona | Corona | Corona | Corona |
| Adhesive | Adhesive | | Aminosilane | Aminosilane | Aminosilane | Aminosilane | Aminosilane |
| layer | | | coupling agent | coupling agent | coupling agent | coupling agent | coupling agent |
| | Adhesive liquid | Amount of silane coupling | 3 | 0.3 | 0.03 | 1.0 | 0.3 |
| | | agent [% by mass] | | | | | |
| | Adhesive layer | Amount of functional group | 0.34 | 0.034 | 0.0034 | 0.11 | 0.034 |
| | | of silane coupling agent | | | | | |
| | | [g/m²] | | | | | |
| | | Amount of amino group of | 1.92 | 0.19 | 0.019 | 0.64 | 0.19 |
| | | silane coupling agent | | | | | |
| | | [mmol/m²] | | | | | |
| | | Average thickness [μm] | 0.34 | 0.034 | 0.0034 | 0.11 | 0.034 |

| | | | | | | |
|---|---|---|---|---|---|---|
| Substrate | Type | CFRP | CFRP | CFRP | CFRP | CFRP |
| Evaluation | Evaluation of hydrophilic retention | C | A | A | A | A |

In Examples 2 to 5, hydrophilicity was retained even after a hydrophilicity retention test was performed, and excellent weather resistance was exhibited even in an actual outdoor environment exposed to rain. On the other hand, in Example 1, it was difficult to retain hydrophilicity for 10 days or more after performing a hydrophilicity retention test.

The disclosure of Japanese Patent Application No. 2023-068089 is incorporated herein by reference in its entirety.

All publications, patent applications, and technical standards in the disclosure are incorporated in the present specification to the same extent as if each individual publication, patent application, and technical standard were specifically and individually noted to be incorporated by reference in the disclosure.

### INDUSTRIAL APPLICABILITY

The adhesive film of the disclosure is suitably used for a protective film for a substrate used outdoors. From the viewpoint of designability, the film is also suitably used as a colored protective film for interior.

1. An adhesive film comprising:
a fluororesin layer comprising a fluororesin and a pigment; and
an adhesive layer that comprises a silane coupling agent having a functional group and that is provided on at least a part of the fluororesin layer,
wherein a content of the pigment in the fluororesin layer is 1.0% by mass or more.

2. The adhesive film according to claim 1, wherein the pigment comprises at least one selected from the group consisting of titanium oxide and carbon black.

3. The adhesive film according to claim 1, wherein the pigment comprises titanium oxide and aluminum oxide.

4. The adhesive film according to claim 1, wherein the functional group of the silane coupling agent comprises at least one selected from the group consisting of an amino group, an epoxy group, and an acrylic group.

5. The adhesive film according to claim 1, wherein an amount of the functional group of the silane coupling agent comprised in the adhesive layer is 0.01 mmol/m² or more.

6. The adhesive film according to claim 1, wherein the fluororesin comprises an ethylene-tetrafluoroethylene copolymer.

7. The adhesive film according to claim 1, wherein the fluororesin layer satisfies the following Relational Formula (1):
$$100 < ( Content ratio of the pigment in the fluororesin layer ( \% by mass ) \times Average thickness of the fluororesin layer ( μm ) ) < 2100 . \qquad Formula ( 1 )$$

8. The adhesive film according to claim 1, wherein the adhesive film has a transmittance of 1.0% or less at a wavelength of 360 nm.

9. The adhesive film according to claim 1, wherein an average thickness of the adhesive layer is 0.5 μm or less.

10. The adhesive film according to claim 1, wherein an amount of the functional group of the silane coupling agent comprised in the adhesive layer is from 0.01 to 1.0 mmol/m².

11. The adhesive film according to claim 1, which is a protective film for outdoor use.

12. An article comprising:
the adhesive film according to claim 1; and
a substrate,
wherein the fluororesin layer, the adhesive layer, and the substrate are provided in this order.

13. The article according to claim 12, wherein the substrate comprises at least one selected from the group consisting of glass, polycarbonate, polyvinyl chloride, epoxy resin, acrylic resin, ethylene-vinyl acetate copolymer resin, modified polyethylene, and fiber-containing resin.

14. The article according to claim 12, wherein the adhesive film is a protective film.

15. The article according to claim 12, which is for outdoor use.
